(19) United States
(12) Patent Application Publication
(10) Pub. No.: US 2006/0253387 A1
(43) Pub. Date: Nov. 9, 2006

(54) Method of Internet Trade Protection for Buyers and Sellers through the Use of Detailed Transaction Negotiation, Pre-Deposit of Funds, Performance Conditioned Release of Funds, Pre-Defined International Exchange Rates, and Defined Dispute Resolution.

(76) Inventor: Jere Vincent Horwitz, Indianapolis, IN (US)

Correspondence Address: JERE V. HORWITZ, 7395 HUNT COUNTRY LANE, ZIONSVILLE, IN, 46077, US

(21) Appl. No.: 10/908,262

(22) Filed: May 4, 2005

(51) Int. Cl. G06Q 99/00; G06Q 30/00; G06Q 40/00

(52) U.S. Cl. 705/39; 705/1; 705/80; 705/26

(57) ABSTRACT

A method is provided for a bundled transaction set encompassing the negotiation of a transaction for goods or services with specific definitions of the elements of the transaction. The method tracks all exchanges between buyer and seller and requires each change to be reviewed, accepted, or modified by the opposing party. The method provides a detailed acceptance procedure for each party to establish the negotiation as a mutually accepted agreement. The method reserves buyer's funds in favor of seller, at a standard agreed upon amount of a universal script, but not available to seller, when the negotiation becomes an agreement. Based on the passage of completion date or upon request of the seller, the buyer accepts or rejects the performance of the seller. At acceptance by buyer, the universal script is released to the seller at the local currency rate that was established at agreement time. Should the buyer reject the performance claim, the method provides for the exchange of objections and responses between the parties and the opportunity for the parties to settle. Failure to agree, causes the method to establish a dispute to be resolved by an agreed upon third party. Upon settlement of the dispute, the universal script is adjusted to the proper parties' accounts at the exchange rate that was established at agreement acceptance time.

### BACKGROUND OF THE INVENTION

The Invention relates to a method of negotiating the terms and conditions of an Internet based business transaction to clearly define the goods and/or services to be exchanged and all related conditions and ensuring for both buyer and seller the proper compensation will be rendered domestically and internationally upon satisfactory vendor performance without exposure; for sellers to credit card, check, or any kind of payment fraud; or exposure for buyers to misrepresentation of goods or services. In the case of dispute, the parties have a defined methodology for defining the dispute and a specific process to resolve the dispute and financially satisfy both buyer and seller.

Currently transactions between buyers and sellers without an established relationship require the use of credit cards, payment in advance of performance, costly transaction fees for international currency conversions, and contain a high risk for financial loss by both buyer and seller.

There is currently a high risk for identity theft, credit card fraud, money order fraud, bank check fraud, and personal information compromise with current transaction processing and payment methods. There is no integrated solution to avoid the risk of financial misrepresentation, mis-appropriation of funds, or mis-representation of goods and services integrated with payment transaction activity. There is currently no total solution to provide financial protection for buyer and seller.

It is desirable for a consolidated approach for transaction negotiation, transaction documentation, transaction agreement, performance verification, transfer of funds domestically and internationally at an agreed exchange, and a clearly defined method of transaction dispute resolution.

The invention solves the problem of fraudulent payment by buyers and fraudulent goods and service representation by sellers for Internet transactions, providing both buyer and seller a level of financial protection not currently available.

### SUMMARY OF THE INVENTION

The method and system of the current invention utilizes a detailed and specific format to standardize the negotiation of the exchange of goods and/or services for compensation over the Internet. It provides for specific definition of the elements making up the transaction and the agreement between partners in the transaction. These specific elements include, but are not limited to, for goods: description, style, finish, make, model, condition, packaging, shipping method, delivery date, and responsibility for damage in transit. For services the specific elements include description, date of service, location.

The price is established in the currency native to the seller's account. The amount in the seller's local currency is set at an exchange rate defined against a global script. The script may be tied to various standards of international currency or commodities. This exchange rate determines the selling price presented to the buyer, if the buyer's account is denominated in a different currency from the seller. The seller is protected from currency fluctuations during the life period of the transaction as the seller's native currency price is established and set when the transaction is generated, not when the transaction is settled.

Each entry element of the transaction is tracked separately and the transaction moves through multiple generations, with each change being tracked, and any change causing the system to automatically notify and request action (modification or acceptance) from the other party. All generations of the transactions are maintained in the system for audit purposes and dispute resolution.

When both parties are satisfied with the transaction, each uses use a security code combination, which is maintained apart from their regular identification and account regular security, to electronically commit to the transaction. The mutual commitment reserves funds from the buyer's account in favor of the seller's account. Neither party has control over the funds. The funds are suspended.

Based on the passage of the performance deadline and/or a request by either seller or buyer, the buyer is requested to verify the transaction is complete. If the buyer verifies the transaction is complete; the funds are released to the control of the seller and permanently removed from the buyer's account.

If the buyer claims performance is not complete, a specific dispute is established. The dispute form is under specific program control by the invention with the buyer entering their exception to any of the elements defining the conditions of the final generation of the transaction. The seller then responds to the exceptions. At any time either party may offer a compromise to the other. Acceptance of the compromise requires both parties to commit in the same manner as for a regular transaction. In this case, the original fund reservation is adjusted to bring the amounts in line with the compromise and the funds are released to the seller and removed from the buyer's account.

In the case of no compromise, at any time during the dispute process, either party may request resolution by the operator of the invention. The operator reviews all generations of the negotiation of the transaction, all generations of the dispute activity, and resolves the amount due seller thus causing the release of the appropriate funds to the seller and the removal of funds from the buyer's account.

The seller is financially protected as the buyer's account is funded outside of the relationship established by the invention and the method of payment is not subject to fraud, stop payment, or any other method that would allow the buyer, at his discretion, to keep the funds due seller. The buyer is financially protected, as the funds are not released to the seller's control until the buyer is satisfied that the seller has provided the goods or services agree upon.

### BRIEF DESCRIPTION OF THE DRAWINGS

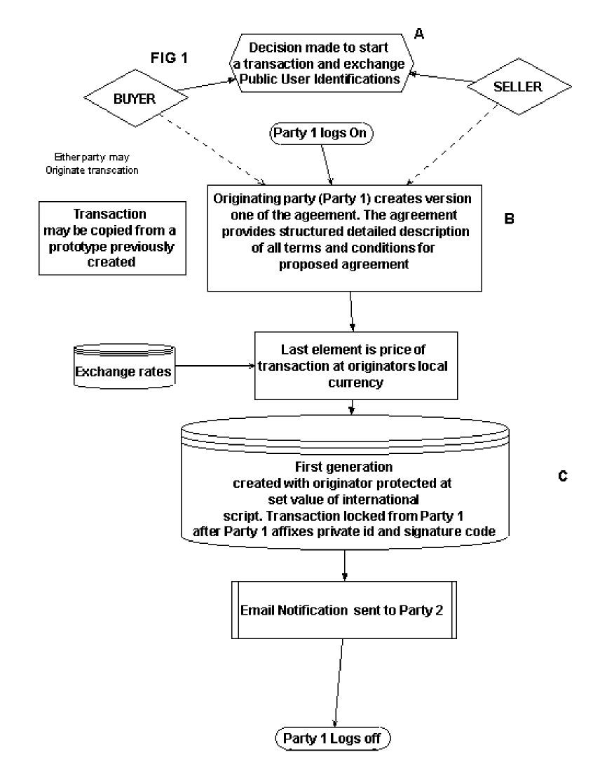

(1) FIG. 1 is a diagram of the procedure to initially establish a transaction

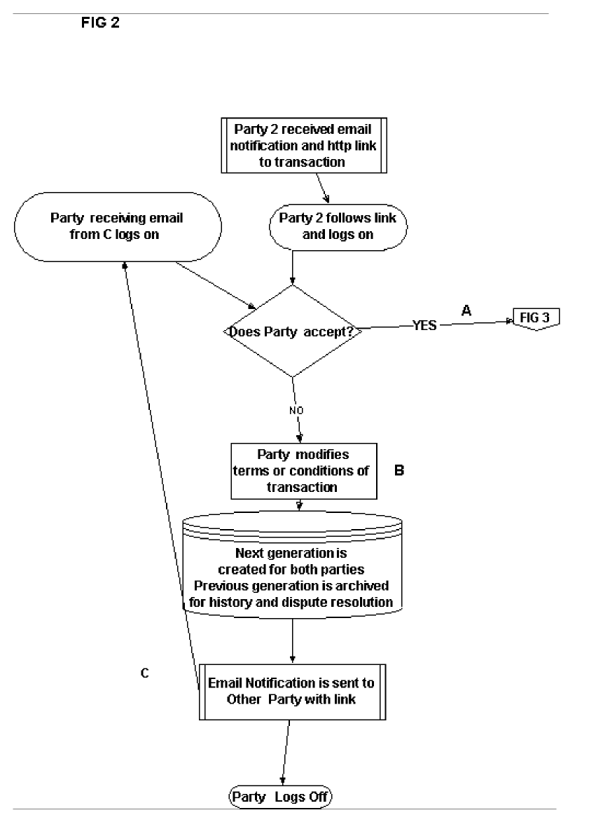

(2) FIG. 2 is a diagram of the procedure to negotiate changes to proposed transactions

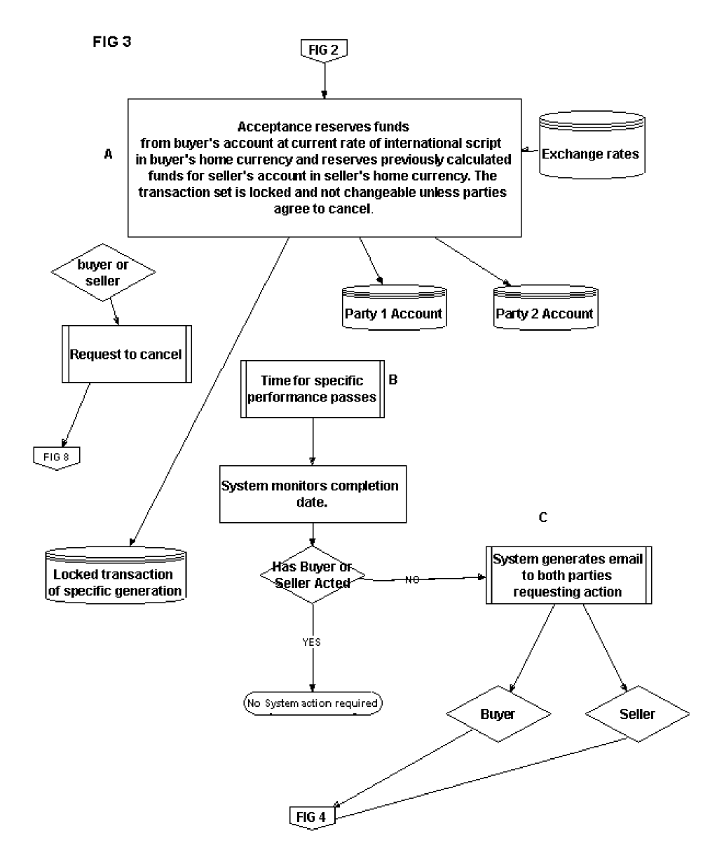

(3) FIG. 3 is a diagram of the procedure to reserve the funds and monitor the completion time frame

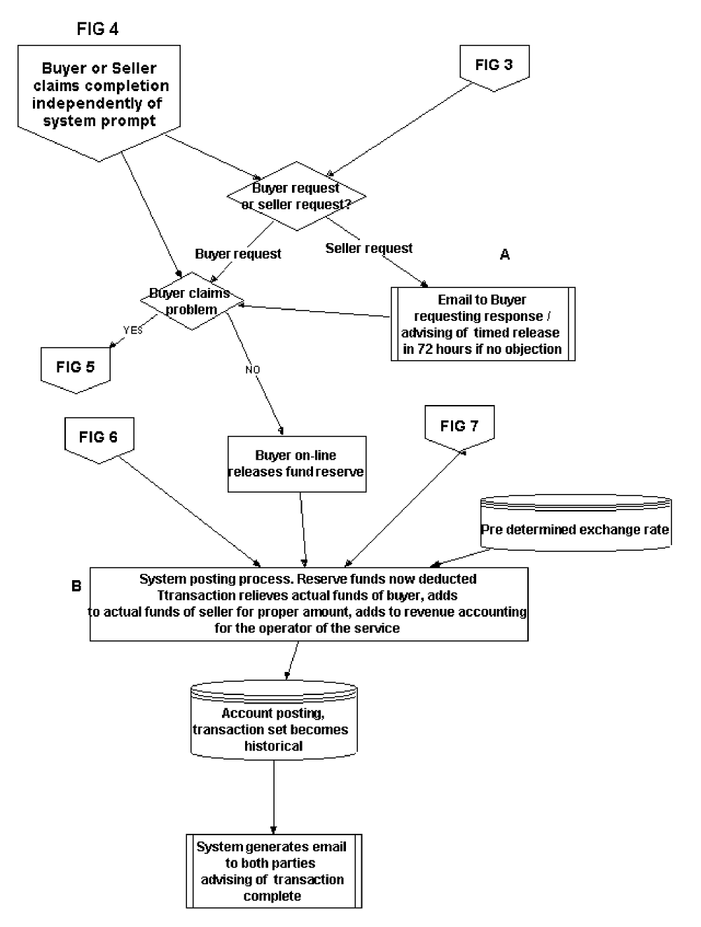

(4) FIG. 4 is a diagram of the completion of the transaction

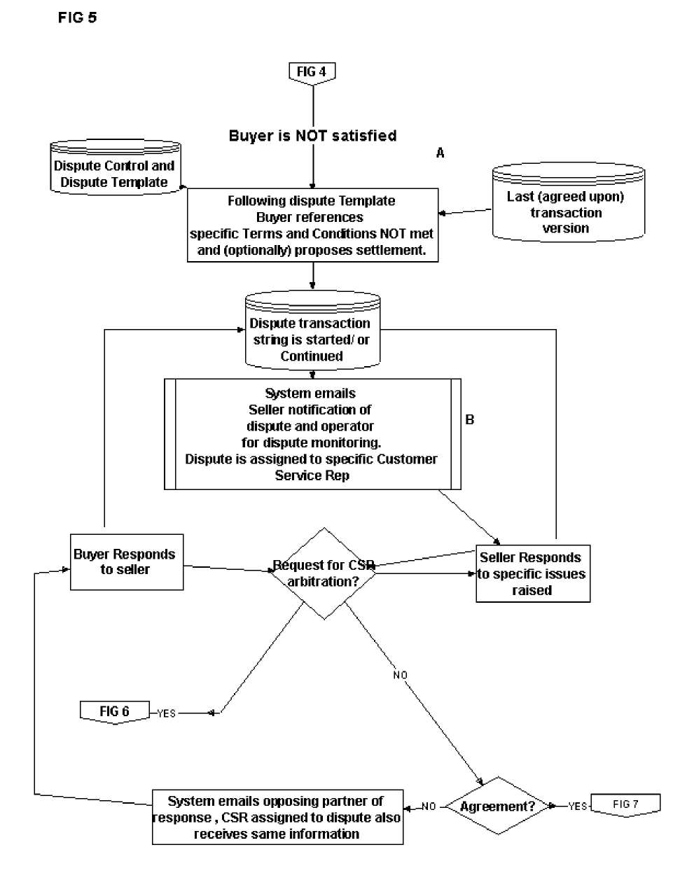

(5) FIG. 5 is a diagram of the dispute negotiation process

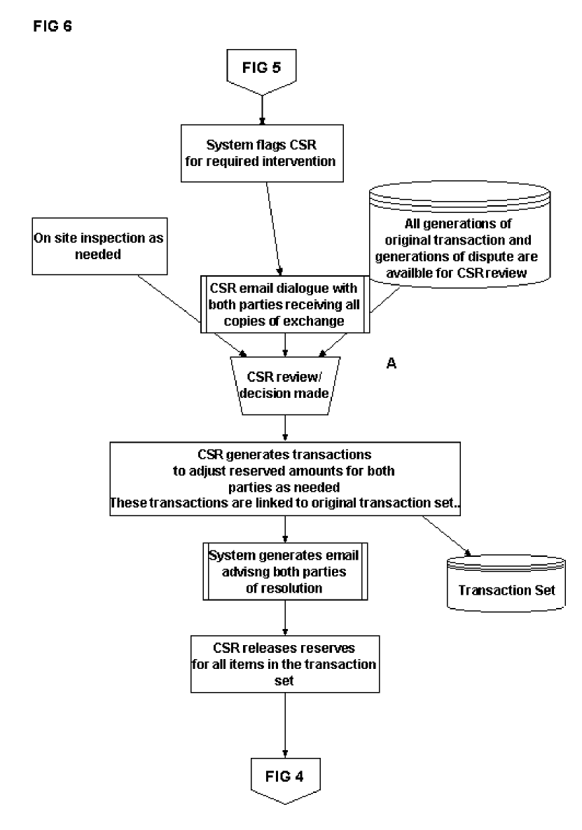

(6) FIG. 6 is a diagram of the site operator dispute resolution process

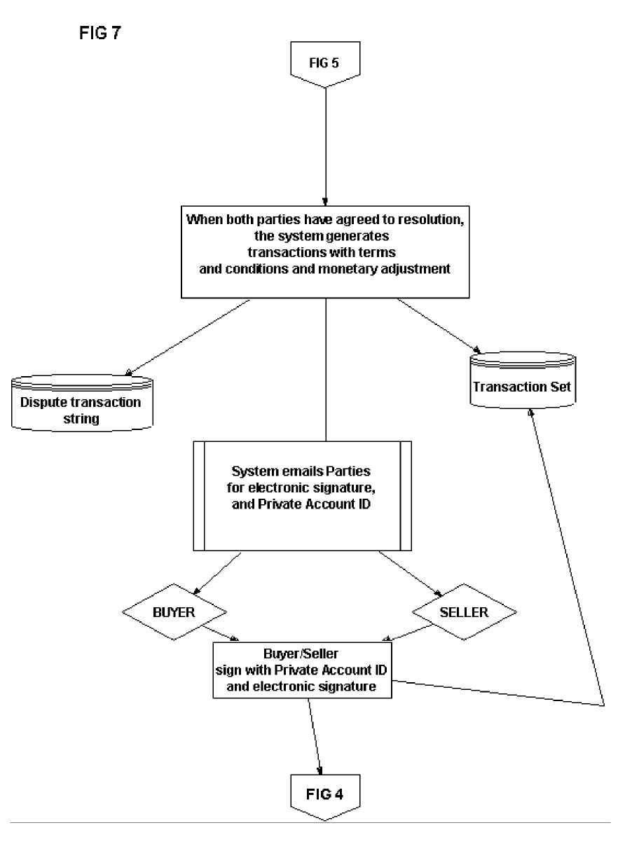

(7) FIG. 7 is a diagram of the parties dispute resolution process

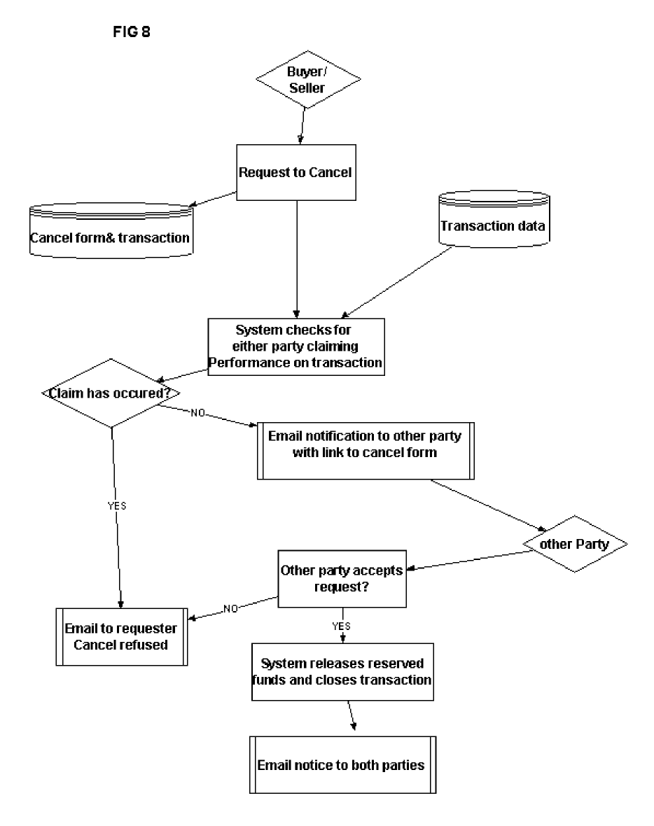

(8) FIG. 8 is a diagram of agreement to cancel

### DESCRIPTION OF THE PREFERRED EMBODIMENT

Two parties, either individuals, business entities, or a combination agree prior to utilizing the invention to engage in a transaction. They exchange the Public Identification by which they are known to the invention. FIG. 1(A). One of the parties, for purpose of explanation, we assume the seller, but that is not a requirement of the invention, is Party 1. Party 1 signs onto the Invention web site using the Public Identification and Password assigned during typical web site enrollment. Party 1 creates the first version of the proposed transaction. FIG. 1(B). It may be created by copying in a previously created “prototype” or by completely filling in the required form. The required form specifically identifies required transaction elements including, but not limited to, the Public Identification of Party 2, the description of the good or service, the applicable information including, but not limited to; Item, model, manufacturer, style, color, finish, condition (new, used, refurbished, remanufactured, working, non-working), shipping method, freight terms, warranty information, return information, insurance information, special conditions, period of time for which offer is valid, delivery or performance date, price of the transaction. The price of the transaction is in the local currency of the account of Party 1. The invention translates this price into the converted value of the universal script as part of the transaction. The exchange rate for this transaction between the seller's local currency and the universal script is set at this time. Party 1 is required to authorize the transaction utilizing the Private account id and Private Electronic Signature code assigned to his account. The authorized transaction is locked from changes by Party 1 until the expiration date and time of the offer. FIG. 1(C). An email is generated to Party 2 advising them of the transaction requiring their response and instructions on the method of retrieving the transaction.

Party 2, buyer, receives notice of the transaction (FIG. 2) and follows the email instructions to log on to the web site of the invention instance and retrieve the transaction. The same data entered by Party 1 is presented. Price and the identity of Party 1 may not be changed. Party 2 may choose to accept the transaction exactly as presented to him and not alter any items. In that case Party 2 is required to authorize the transaction utilizing the Private account id and Private Electronic Signature code assigned to his account. FIG. 2(A). In that instance the invention would flow to the section starting on FIG. 3.

Party 2 may changes any of the other items describing the detail of the transaction within the allowed parameters for each element. (FIG. 2(B). When done entering the changes, Party 2 is required to authorize the transaction utilizing the Private account id and private electronic signature code assigned to his account. This action generates the next generation of the transaction. The first generation is now archived. An email is generated to Party 1 advising them of the modified transaction requiring their response and instructions providing the method of retrieving the transaction. FIG. 2(C). This exchange continues with each modification generating a new transaction generation until the time limit for a response has passed or one party enters their intention to cease negotiation thus ending the transaction, or both parties affix their Private Account id and Private Electronic Signature code to the same generation of transaction leading to the activity on FIG. 3.

When both parties have accepted the same generation of the transaction, the embodiment of the invention causes funds to be reserved from the buyer's account. FIG. 3(A). The amount reserved is the buyer's local currency equivalent of the international script amount established when the first generation of the transaction was created. The transaction is locked and not changeable by either party, unless both parties agree to cancel the transaction. (FIG. 8). Agreement to cancel is accomplished as follows: one party requests a cancellation; the system verifies, before allowing the request to proceed, that the other party has not claimed that the required performance under the transaction has occurred. If a claim for performance exists, the request to cancel is rejected by the system. If there is no claim of performance, the system sends an email notification to the opposing party with the request to cancel. Both parties affix their Private account id and Private Electronic Signature code to the cancel transaction to indicate their acceptance of the cancellation. In the case that both parties agree to the cancellation, the funds originally placed on hold in the buyer's account are released to the buyer's control. The amount shown on hold but allocated to the seller's account is removed from the seller's account. The transaction set is cancelled and non-accessible to the users. If the party being asked to cancel refuses to cancel; the original transaction set remains active.

The invention monitors the passage of time for specific performance as called for in the transaction. FIG. 3(B). When the period of specific performance passes, and if there has been no request from either party to release the funds in reserve, the system notifies both parties of the need for specific action to proceed in settling the transaction. FIG. 3(C).

In response to the system request, or independently of the request, either buyer or seller may, through the user interface, request settlement of the transaction. (FIG. 4). If the request is from the seller, the invention generates email notification that the settlement will occur automatically, within a specified time frame, if there is no response from buyer. FIG. 4(A) If the buyer requests settlement or if there is no response to the notification generated by the seller's request, sent to the buyer; the invention generates the settlement activity. FIG. 4(B). The funds previously in reserve for the transaction on the buyer's account are removed from the buyer's account balance. The funds previously allocated to, but reserved, on the seller's account are released to the seller's control (less any appropriate fee). Both parties to the transaction receive notification of the settlement.

In the case wherein the buyer is not satisfied, the invention provides for the establishment, negotiation, and settlement of disputed transactions. (FIG. 5). Buyer establishes a dispute by accessing the dispute template and referencing the transaction. Each item of condition of the transaction is presented and the Buyer has the opportunity to record his reason of dissatisfaction with the meeting of that particular transaction element. FIG. 5(A). Buyer also may record his suggested means of settlement (return of items, adjustment of amount, additional service to correct problem). The buyer utilizes the Private account id and Private Electronic Signature code assigned to his account to create the first generation of the dispute, which is linked through a reference to the original agreed upon transaction. The buyer's first generation of the dispute is locked. The establishment of the dispute suspends the settlement process for the transaction. The seller receives notification via email of the dispute along with instructions for accessing the dispute. The operator of the invention is also notified and copied on all exchanges of the dispute. The operator's Customer Service Representative (CSR) monitors the activity to ensure the dispute moves toward resolution between the parties. FIG. 5(B). The seller accesses the dispute and may respond to the specific points of the buyer, thus, creating a next generation of the dispute; or the seller may accept the dispute resolution put forward by the buyer.

If the seller responds and does not accept the buyer's suggested resolution, the result is returned to the buyer and the cycle continues until either both parties agree to a proposed resolution or either party requests that the operator of the invention settle the dispute.

In the instance that both parties agree to the resolution, (FIG. 7) the invention generates additional transactions for the proper monetary amount and with the complete embodiment of the agreed solution to each account. The monetary adjustments are reserved for the respective accounts pending the execution of the solution. For example, the parties might agree to a simple reduction of the monetary value of the transaction. In that case, the value change would be reserved in favor of the buyer and in opposition of the seller. Since there would be no performance time consideration the original transaction and the dispute transaction would be released by the invention for posting, thus, closing the total transaction set. If the settlement calls for a return of goods, exchange of goods, or additional services, the transaction settlement remains suspended until the performance time period expires or either buyer or seller claim completion of the terms of the dispute. The dispute is then settled in the same way as the original transaction (FIG. 4). Upon releasing the dispute transaction for settlement the original transaction is released also. The net effect for both buyer and seller is the agreed upon amount.

In the case the party requests the operator of the invention to settle the dispute (FIG. 6), the designated representative of the operator of the invention reviews all generations of the transaction and the related dispute and establishes the settlement. The designated representative (CSR) of the invention operator generates the necessary dispute settlement transactions into the system and releases the transaction and the dispute for settlement. FIG. 6(A). These transactions appear on the specific accounts of the parties involved in the transaction but are locked and non-changeable by the parties. The original transaction and the dispute transactions are released simultaneously (FIG. 4), with the net effect being the amount due under the total transaction set.

The settled transactions become part of the account balances under the control of the respective parties.

What is claimed is:

1. A method of negotiating and executing the exchange of compensation for goods or services via the Internet comprising:
Buyer and seller defining all related items of the transaction in a standardized and specific form and clearly defining various elements including, but not limited to description, price, freight conditions, item condition, deadline for goods transfer or service performance, make of goods, model of goods, packaging;
Determination of a standard unit of price based on a universal script related to the currency unit of each participant in the transaction so that both buyer and seller see the transaction in both their own location currency and the system-wide universal script;
Reservation of buyer's funds in favor of seller when the transaction is agreed upon;
Transfer of funds from buyer's account to seller's account, at the exchange rate as of the day of the accepted agreement, upon buyer's agreeing that specific performance has occurred to satisfy the transaction conditions;
Suspension of funds transfer and establishment and resolution of performance objections raised by buyer in respect to seller's goods or services.

2. The method of claim 1 where negotiations take place through multiple generations of the transaction and a detailed trail of each parties negotiating position is archived.

3. The method of claim 1 where is each change to a transaction is automatically presented to the opposite party for comment or acceptance.

4. The method of claim 1 where each party agrees to the detailed terms of the transaction and affixes their respective electronic signature causing the funds reservation from buyer to seller to take place at the proper exchange rate for international transactions.

5. The method of claim 1 wherein the transaction is valued for both parties in a universal script and translated to the local currency for each account.

6. The method of claim 1 wherein the passage of time from agreement or the request of seller for access to reserved funds causes the buyer to react to electronically agree to the performance or to raise objection.

7. The method of claim 1 to establish the objection for dispute resolution via the Internet using a specified format.

8. The method of claim 1 to control the presentation of disputes and rebuttals to each involved party with a detailed audit trail of every exchange.
